(19) United States
(12) Patent Application Publication
(10) Pub. No.: US 2022/0314982 A1
(43) Pub. Date: Oct. 6, 2022

(54) CONTROL DEVICE

(71) Applicant: DENSO CORPORATION, Kariya-city (JP)

(72) Inventor: Yuuta MATSUMOTO, Kariya-city (JP)

(21) Appl. No.: 17/847,813

(22) Filed: Jun. 23, 2022

Related U.S. Application Data
(63) Continuation of application No. PCT/JP2021/016637, filed on Apr. 26, 2021.

(30) Foreign Application Priority Data
Apr. 30, 2020 (JP) 2020-080310

(51) Int. Cl. B60W 30/095; B60W 50/14; B60W 30/09

(52) U.S. Cl. CPC B60W 30/0956; B60W 50/14; B60W 30/09; B60W 2540/225; B60W 2540/20; B60W 2540/12

(57) ABSTRACT

In a control device for a vehicle , state information indicating a state of a driver, environmental information indicating an environment around the vehicle, and vehicle information are acquired. An object existing in a vicinity of the vehicle to be alerted to the driver is detected from the environmental information. At one of a process for determining whether to output a warning that the object exists and a process for setting an intensity of the warning to be output is executed based on at least one of the state information and the environmental information when the detection unit detects the object. The warning is output according to a result of the process.

### CROSS REFERENCE TO RELATED APPLICATION

The present application is a continuation application of International Patent Application No. PCT/JP2021/016637 filed on Apr. 26, 2021, which designated the U.S. and claims the benefit of priority from Japanese Patent Application No. 2020-080310 filed on Apr. 30, 2020. The entire disclosures of all of the above applications are incorporated herein by reference.

### TECHNICAL FIELD

The present disclosure relates to a control device.

### BACKGROUND

There are known technologies called FCTA and RCTA that alert the driver of a vehicle when it detects another vehicle approaching the vehicle from the front left and right and the rear left and right when the vehicle enters an intersection or a road with poor visibility. Here, FCTA is an abbreviation for Front Cross Traffic Alert, and RCTA is an abbreviation for Real Cross Traffic Alert.

A conceivable technique teaches a driving support device that outputs an appropriate warning according to a degree of danger to the driver of the vehicle, for example, when it is determined that there is a possibility of contact between the vehicle and another object while the vehicle approaches a crossroads. In this driving support device, the possibility of contact between the vehicle and other objects is determined based on the position, traveling direction and speed of the vehicle and the position, traveling direction and speed of other objects other than the vehicle.

### SUMMARY

According to an example, in a control device for a vehicle , state information indicating a state of a driver, environmental information indicating an environment around the vehicle, and vehicle information are acquired. An object existing in a vicinity of the vehicle to be alerted to the driver is detected from the environmental information. At one of a process for determining whether to output a warning that the object exists and a process for setting an intensity of the warning to be output is executed based on at least one of the state information and the environmental information when the detection unit detects the object. The warning is output according to a result of the process.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing a configuration of a control system;

FIG. 2 is a diagram showing a mounting position of a peripheral vision device; and

FIG. 3 is a flowchart of a warning control process.

### DETAILED DESCRIPTION

In a driving support device according to the conceivable technique, when it is determined that there is a possibility of contact based on the position information between the vehicle and other objects, the device outputs the warning to the driver even in the following case. For example, if the driver is not willing to start the vehicle, or if the driver is already fully aware of the possibility of contact with other objects and knows that the vehicle cannot be started, the device outputs the warning to the driver. That is, as a result of the inventor's detailed examination, in the above-mentioned driving support device, even when the need for warning is low, an excessive warning is output, so that the driver feels the warning annoying.

One aspect of the present embodiments is to provide a control device capable of suppressing the output of an excessive warning when the need for warning is low for an object existing in the vicinity of the vehicle.

One aspect of the present embodiments is a control device mounted on a vehicle, which includes an acquisition unit, a detection unit, a processing unit, and an output unit. The acquisition unit is configured to acquire state information indicating the state of the driver of the vehicle, environmental information indicating the environment around the vehicle, and vehicle information including at least the current position of the vehicle. The detection unit is configured to detect an object existing around the vehicle that should alert the driver from the environmental information. When an object is detected by the detection unit, the processing unit is configured to execute at least one of the process for determining whether to output a warning that the object exists based on at least one of the state information and the environmental information, and the process for setting the strength to output the warning. The output unit is configured to output a warning according to the result of the processing executed by the processing unit.

In such a configuration, when an object existing in the vicinity of the vehicle that should be alerted to the driver of the vehicle is detected, at least one of the process for determining whether or not to output a warning based on at least one of the state information and the environmental information, and the process for setting the intensity to output a warning is executed. As a result, even when the object is detected, and if the need for warning is low, it is possible to interrupt outputting the warning or to change the intensity of outputting the warning. Therefore, it is possible to suppress the output of an excessive warning when the need for warning is low for an object existing in the vicinity of the vehicle.

Exemplary embodiments of the present disclosure will be described below with reference to the drawings.

### 1. Configuration

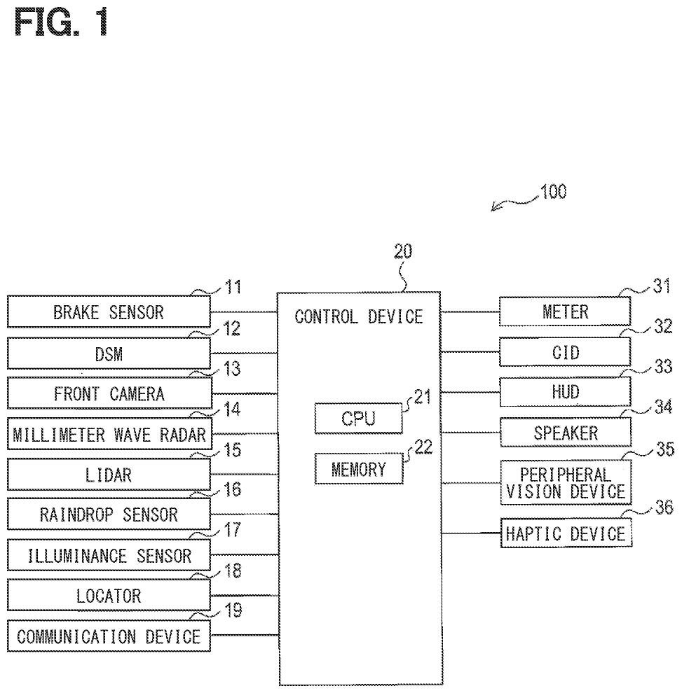

The control system 100 shown in FIG. 1 is a system mounted on a vehicle and controls the output of a warning for alerting the driver of the vehicle to an object existing around the vehicle. The control system 100 includes a brake sensor 11, a driver status monitoring system (hereinafter referred to as DSM) 12, a front camera 13, a millimeter wave radar 14, a lidar device (hereinafter referred to as LIDAR) 15, and a raindrop sensor 16, an illuminance sensor 17, a locator 18, a communication device 19, a control device 20, a meter 31, a center information display (hereinafter referred to as CID) 32, a head-up display (hereinafter referred to as HUD) 33, a speaker 34, a peripheral vision device 35, and a haptic device 36. Hereinafter, the vehicle equipped with the control system 100 is referred to as “an own vehicle”.

The brake sensor 11 is a sensor that detects the brake operation of the driver of the own vehicle. In the present embodiment, the brake sensor 11 detects the brake pressure, which is the amount of depression of the brake pedal, as information on the brake operation. The brake sensor 11 outputs a signal corresponding to the detected brake pressure to the control device 20.

The DSM 12 includes a near-infrared light source and a near-infrared camera (not shown), and a control unit for controlling them. The DSM 12 is arranged on, for example, the steering column cover, the upper surface of the instrument panel, or the like with the near-infrared camera facing the driver's seat side of the own vehicle. The DSM 12 uses the near-infrared camera to capture the driver's head to which the near-infrared light is emitted from the near-infrared light source. The control unit performs an image analyzing process to the image captured by the near infrared light camera. The control unit acquires face information including, for example, the driver's line of sight and face orientation. In the DSM 12, it is also possible to authenticate the driver personally based on the face information. The DSM 12 outputs the detected face information to the control device 20.

The front camera 13 is an image pickup device mounted in front of the own vehicle and capable of taking an image of the front of the own vehicle. The front camera 13 outputs a signal representing the captured image to the control device 20. The own vehicle may be equipped with a camera other than the front camera 13.

The millimeter-wave radar 14 and the LIDAR 15 are distance measuring sensors that detect the relative position and relative speed of peripheral objects that exist in the vicinity of the own vehicle with respect to the own vehicle as a reference position and a reference speed. In the present embodiment, other vehicles, pedestrians, and the like existing in the vicinity of the own vehicle are detected as peripheral objects. The millimeter wave radar 14 and the LIDAR 15 output a signal corresponding to the relative position and relative velocity of the detected peripheral object to the control device 20. A ranging sensor other than the millimeter-wave radar 14 and the LIDAR 15 may be used.

The raindrop sensor 16 is a sensor that detects the amount of rainfall based on the raindrops adhering to the windshield of the own vehicle in a rainy state. The raindrop sensor 16 outputs the detection result to the control device 20.

The illuminance sensor 17 is a sensor that detects the illuminance around the own vehicle. The illuminance sensor 17 outputs a signal corresponding to the detected illuminance to the control device 20.

The locator 18 is a device for positioning the current position of the own vehicle. The locator 18 is realized by using, for example, a GNSS receiver (not shown), an inertial sensor, a map database (hereinafter referred to as a map DB), or the like. The GNSS is an abbreviation for Global Navigation Satellite System. The GNSS receiver is a device that detects the current position of the GNSS receiver by receiving a positioning signal transmitted from a positioning satellite constituting the GNSS. The inertial sensor is, for example, a gyro sensor and an acceleration sensor. The map DB stores map data including information on roads, location information of intersections, location information of traffic lights, and the like. The locator 18 identifies the current position of the own vehicle by combining the positioning result of the GNSS receiver, the measurement result of the inertial sensor, and the map data, and outputs the information indicating the specified current position to the control device 20.

The communication device 19 is a communication device for performing vehicle-to-vehicle communication with other vehicles, road-to-vehicle communication with a roadside communication device, communication with a mobile communication terminal, and the like. The control device 20 acquires information on peripheral objects via the communication device 19.

The control device 20 mainly includes a well-known microcomputer having a CPU 21 and a semiconductor memory such as RAM or ROM (hereinafter referred to as memory 22). The CPU 21 executes a program stored in the memory 22, which is a non-transitory tangible storage medium. By the execution of the program, a method corresponding to the program is performed. Specifically, the control device 20 executes the warning control process described later according to the program. The control apparatus 20 may include one microcomputer, or may include a plurality of microcomputers. The memory 22 stores the warning time, which is the time when the warning is output, and the number of warnings, which is the number of times the warning is output, as the warning control process is executed. Further, the memory 22 may store information regarding the past driving history in association with the personal authentication by the DSM 12.

The meter 31 and the CID 32 are in-vehicle displays capable of displaying images, characters, and the like. The meter 31 and the CID 32 are arranged at positions that can be visually recognized by the driver of the own vehicle. The meter 31 can stimulate the driver's vision by generating light in addition to displaying the traveling speed of the vehicle, a caution image for calling attention, a warning image indicating a warning, and the like. Further, the CID 32 can also generate a stimulus by light, like the meter 31, in addition to displaying a map for car navigation, a caution image, a warning image, and the like. The meter 31 and the CID 32 display a caution image or a warning image based on the output regarding the warning from the control device 20, and generate light in a predetermined light emitting mode. The predetermined light emitting mode includes, for example, brightness, color, presence/absence of blinking, blinking interval, and the like.

The HUD 33 is a device that projects an image, characters, and the like onto the windshield of the own vehicle, and the image is displayed superimposed on the scenery in front of the own vehicle. The HUD 33 is provided on the instrument panel of the own vehicle. The HUD 33 can also generate a stimulus by light, like the meter 31 and the CID 32, in addition to displaying a framework image surrounding the peripheral object in order to gaze at the peripheral object, a caution image, a warning image, and the like. The HUD 33 display a caution image or a warning image based on the output regarding the warning from the control device 20, and generate light in a predetermined light emitting mode.

The speaker 34 is an in-vehicle speaker shared with the CID 32, an audio device, and the like. The speaker 34 can stimulate the driver's hearing by generating sound. The speaker 34 generates a sound in a predetermined ringing mode based on the output regarding the warning from the control device 20. The predetermined sounding modes include, for example, volume and timbre.

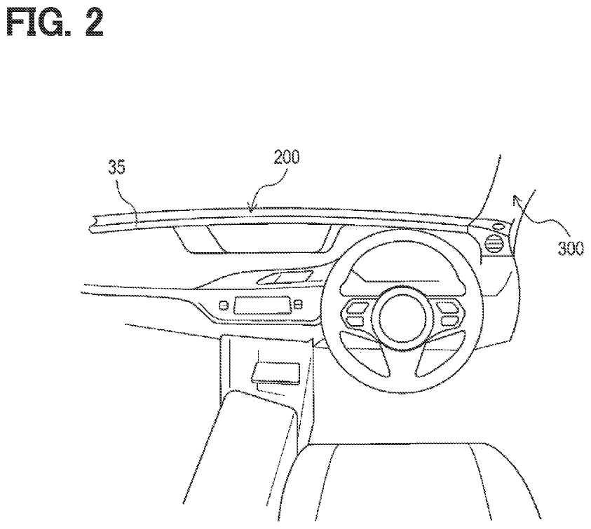

The peripheral vision device 35 is a light emitting device realized by using an LED or the like, and can stimulate the driver's vision by generating light. The peripheral vision device 35 generates light in a predetermined light emitting mode based on the output regarding the warning from the control device 20. The peripheral vision device 35 is arranged at a position within the peripheral visual field of the driver who is looking toward the front of the own vehicle. Here, the peripheral visual field is a region that is disposed out of the effective visual field and is disposed within the driver's field of view. The effective field of view is assumed to be within 30 degrees in the vertical direction and within 20 degrees in the horizontal direction, based on the direction in which the line of sight is facing. As shown in FIG. 2, the position in the vehicle compartment where the driver who is looking toward the front of the own vehicle enters the peripheral visual field is, for example, the upper surface of the instrument panel 200 and the surface portion of the front pillar 300 on the vehicle compartment side. In the present embodiment, the peripheral vision device 35 is realized by arranging a plurality of light emitting elements on the instrument panel 200 along the vehicle width direction. The plurality of light emitting elements constituting the peripheral vision device 35 may be arranged along a portion connecting the lower end portion of the windshield and the upper surface of the instrument panel 200. Further, the plurality of light emitting elements constituting the peripheral visual field device 35 may be arranged along the edge portion on the seat side on the upper surface of the instrument panel 200.

The haptic device 36 is a device capable of stimulating the tactile sensation of a driver by generating vibration or the like. As the haptic device 36, for example, a vibrator arranged in a portion in contact with the driver's body such as a steering wheel, an accelerator pedal, a brake pedal, a driver's seat, and a seat belt can be adopted. The haptic device 36 generates vibration in a predetermined vibration mode based on the output regarding the warning from the control device 20. The predetermined vibration modes include, for example, intensity, amplitude and generation interval.

The haptic device 36 may not be limited to vibration, and may be, for example, a device that applies a pushing force to the driver's hand or makes an illusion of a traction force by using a mechanism that performs asymmetric vibration. The tactile sensation also includes a warm sensation, and the haptic device 36 may use heat to stimulate the tactile sensation of the driver. The medium that transfers heat may be a steering wheel or the like, or air blown out from an air conditioner or the like.

### 2. Processing

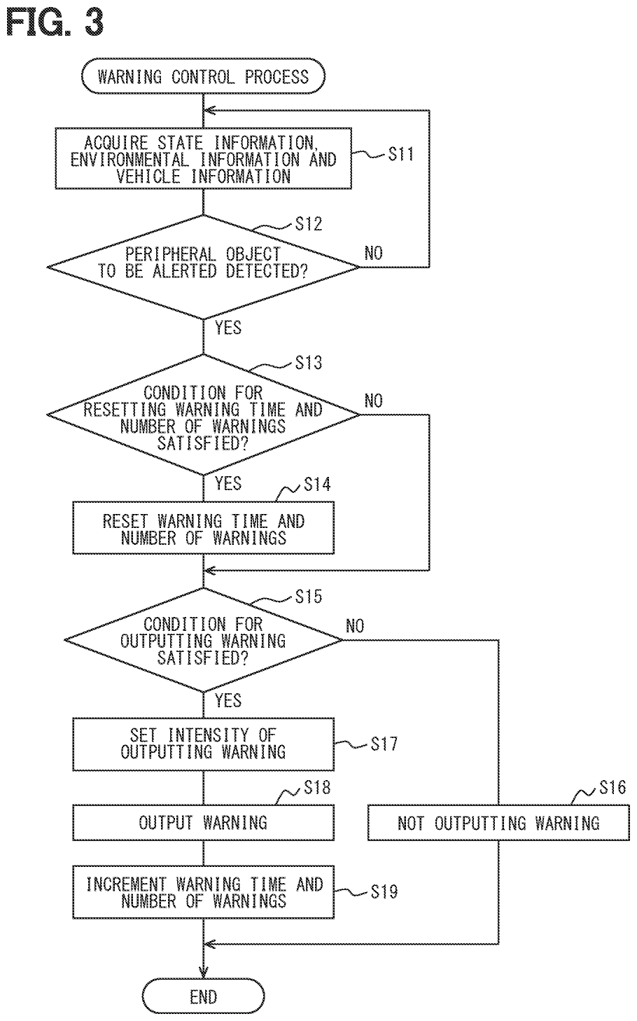

Next, the warning control process executed by the control device 20 will be described with reference to the flowchart of FIG. 3. This warning control process is periodically executed while the ignition switch is on.

First, in S11, the control device 20 acquires state information indicating the state of the driver of the own vehicle, environmental information indicating the environment around the own vehicle, and vehicle information including at least the current position of the own vehicle.

In the present embodiment, the brake pressure and the driver's face information are acquired as the state information. Further, as the environmental information, the captured image, the information of the peripheral object including the relative position and the relative speed of the peripheral object and the own vehicle, the warning time, the number of warnings, the collision prediction time, the weather information and the brightness information are acquired. Here, the collision prediction time is the time at which a collision between a peripheral object and the own vehicle is predicted. The collision prediction time is calculated based on the information of surrounding objects and the vehicle information included in the environmental information. Specifically, the collision prediction time is a value obtained by dividing the inter-vehicle distance calculated from the relative position between the peripheral object and the own vehicle by the relative speed between the peripheral object and the own vehicle. Further, the weather information is information indicating the weather around the own vehicle estimated based on the captured image, the amount of rainfall, and the illuminance. The brightness information is information indicating the brightness outside the own vehicle according to the illuminance. In addition, only one of the warning time and the number of warnings may be acquired. Further, as the state information, other information indicating the state of the driver of the own vehicle may be acquired, and as the environmental information, other information indicating the environment around the own vehicle may be acquired.

Subsequently, in S12, the control device 20 determines whether or not a peripheral object to be alerted to the driver of the own vehicle is detected from the environmental information. In the present embodiment, for example, when an object approaching the own vehicle is detected among the peripheral objects based on the captured image acquired as environmental information and the information of the peripheral object, it is determined that the peripheral object that should be alerted to the driver of the own vehicle has been detected.

When the control device 20 determines in S12 that it has not detected a peripheral object that should be alerted the driver of the own vehicle, the control device 20 returns the process to S11.

On the other hand, when the control device 20 determines in S12 that a peripheral object to be alerted to the driver of the own vehicle is detected, the process shifts to S13.

In S13, the control device 20 determines whether or not the condition for resetting the warning time and the number of warnings is satisfied based on the vehicle information. In the present embodiment, for example, when it is determined that the two-step stop has been performed based on the current position of the own vehicle, the brake operation, and the like, it is determined that the reset condition is satisfied. Further, for example, based on the current position of the own vehicle, in the new environment, for example, when the intersection is different from another intersection in which the warning was output in the previous cycle, it is determined that the reset condition is satisfied.

When the control device 20 determines in S13 that the condition for resetting the warning time and the number of warnings is satisfied, the control device 20 shifts the process to S14.

In S14, the control device 20 resets the warning time and the number of warnings stored in the memory 22.

On the other hand, when the control device 20 determines in S13 that the condition for resetting the warning time and the number of warnings is not satisfied, the control device 20 skips the processing in S14 and shifts the processing to S15.

In S15, the control device 20 determines whether or not the condition for outputting a warning that there is a peripheral object to be alerted to the driver of the own vehicle is satisfied based on the state information and the environmental information. In the present embodiment, it is determined whether or not to output the warning based on whether or not the condition for outputting the warning is satisfied. Specifically, when at least one of the following conditions (A) to (E) is satisfied, it is determined that the condition for outputting the warning is not satisfied, that is, the warning is not output.

(A) The depression of the brake pedal of the own vehicle that satisfies a predetermined condition is detected from the brake operation information. Specifically, the brake pressure is equal to or higher than a predetermined pressure.

(B) When a traffic light that displays a display that restricts the traveling of the own vehicle is detected based on the captured image, the traffic light shows a red light.

(C) The driver's face information satisfying a predetermined condition is detected. Specifically, the time change of the driver's face information satisfying a predetermined condition is detected.

(D) At least the warning time is equal to or longer than a predetermined time, or at least the number of warnings is equal to or larger than a predetermined number of times.

(E) The predicted collision time with a peripheral object is equal to or longer than a predetermined threshold value.

Here, when the condition of (A) is satisfied, that is, when the brake pedal is strongly depressed, it is considered that the driver has a low intention to start the vehicle and the need for warning is low, so that it is the state in which no warning is output. The predetermined pressure related to the brake pressure may be set to an individual value from the past driving history or the like associated with the personal authentication stored in the memory 22 based on the personal authentication by the DSM 12.

Further, when it is known that the driver cannot start the vehicle when the condition of (B) is satisfied, that is, when the red light is detected at the traffic light of the road on which the own vehicle is traveling, it is considered that the need for warning is low. Therefore, when the condition of (B) is satisfied, the warning is not output. The traffic light on the travel path for detecting the red signal in the captured image may be limited to a traffic light that is presumed to exist within a certain distance from the own vehicle.

Further, when the condition of (C) is satisfied, there is a high possibility that the driver has performed a sufficient safety confirmation action, and it is considered that there is little need to output a warning, so that it is the state in which the warning is not output. As a predetermined condition regarding the time change of the face information of the driver, for example, it is conceivable that the change amount of the face information may be a condition. In this case, it may be determined that the warning is not output when the amount of change in the face information is equal to or greater than a predetermined threshold value. For example, when the driver looks left and right to check the safety and looks around the vehicle, the cumulative value of the amount of change in the face information within a predetermined time may increase. Therefore, when the amount of change based on the time change of the driver's line of sight or face orientation included in the face information is large, the possibility is high such that the driver has sufficiently confirmed the safety of the environment around the vehicle including surrounding objects, so that it may be determined that no warning is output.

On the other hand, even when the amount of change is small, if the direction in which the peripheral object is detected continues to be detected, the driver may be watching the peripheral object carefully, and the possibility is high such that the driver may take sufficient safety confirmation actions. Therefore, even if the amount of change based on the time change of the driver's line of sight or face orientation included in the face information is small, it may be determined that a warning is not output on condition that the direction in which the peripheral object is detected continues to be detected. That is, as another example of the predetermined condition regarding the time change of the face information of the driver, the change amount of the face information is equal to or less than the predetermined threshold value, and the visual recognition in the direction in which the peripheral object is detected from the face information is detected for a period equal to or more than the predetermined time, it may be determined that no warning is output.

Even when a warning is output, if the condition (C) is satisfied after that, the subsequent warnings may not be output. It should be noted that it may be determined whether or not the condition for outputting the warning is satisfied based on the information such as the facial expression that can be detected from the face information.

Further, when the condition (D) is satisfied, that is, when the driver is warned for a sufficient time or the sufficient number of times, it is highly likely that the driver has already fully recognized the possibility of contact with another object and the driver cannot start driving the vehicle, so that it is considered that the necessity of the warning is low. Therefore, when the condition of (D) is satisfied, the warning is not output.

In addition, when the condition (E) is satisfied, that is, when the estimation time to collision with the peripheral object is long, the possibility of a collision between the own vehicle and the peripheral object is low, and it is considered that the need for warning is low. Therefore, no warning is output. That is, when the estimation time for the collision with a peripheral object is long, the following can be considered. For example, it is conceivable that the situation may change to a situation in which a collision is unlikely to occur due to changes in the traveling conditions such as the traveling speed and the traveling direction. Further, for example, it is conceivable that the driver of the own vehicle may sufficiently recognize the surrounding objects before the collision and have sufficient time to avoid the collision, so that the collision can be avoided. For this reason, when the estimation time to collision with a peripheral object is long, there is a high possibility that the situation does not necessarily require the output of a warning, so it is possible to set the state in which the warning is not output.

It should be noted that the predetermined threshold value regarding the collision prediction time used in the condition (E) may be changed according to the direction in which the surrounding vehicle exists with respect to the own vehicle, the weather information, and the brightness information.

For example, when a peripheral object existing behind the own vehicle that should alert the driver is detected, the visibility from the driver is poor as compared with the case where the peripheral object exists in front of the own vehicle. Therefore, when the peripheral object is disposed behind the own vehicle, it is determined whether or not the condition (E) is satisfied by raising a predetermined threshold value regarding the collision prediction time as compared with the case where the peripheral object is in front of the own vehicle.

Further, for example, when the weather is bad such as cloudy weather, rain, fog, and snow, the visibility of the driver regarding the environment around the own vehicle is poor as compared with the case where the weather is fine. Therefore, when the weather is bad, it is determined whether or not the condition of (E) is satisfied by raising a predetermined threshold value regarding the collision prediction time as compared with the case of fine weather.

Further, for example, when the illuminance is equal to or less than a predetermined threshold value, that is, when the outside of the own vehicle is dark, the visibility of the driver regarding the environment around the own vehicle is poor as compared with the case where the outside of the own vehicle is bright. Therefore, when the outside of the own vehicle is dark, the predetermined threshold value regarding the collision prediction time is raised as compared with the case where the outside of the own vehicle is bright, and it is determined whether or not the condition of (E) is satisfied. For example, in the case of nighttime, the driver's visibility of the environment around the vehicle is poorer than in the daytime, so the predetermined threshold value for the collision prediction time is raised as compared with the daytime, and it is determined whether the condition (E) is satisfied.

When the control device 20 determines in S15 that the condition for outputting the warning is not satisfied, the control device 20 shifts the process to S16.

In S16, the control device 20 does not output a warning from the meter 31, the CID 32, the HUD 33, the speaker 34, the peripheral vision device 35, and the haptic device 36 that a peripheral object exists. After that, the warning control process of FIG. 3 is terminated. When a warning is output in the previous cycle, the warning output is stopped.

When the control device 20 determines in S15 that the condition for outputting the warning is satisfied, the control device 20 shifts the process to S17. That is, when it is determined that a warning is to be output, the process shifts to S17.

In S17, the control device 20 sets the intensity for outputting a warning based on the state information and the environmental information. Specifically, the intensity for outputting a warning is set as shown in the following (F) to (I). In the present embodiment, for example, among the intensities set as shown in (F) to (I), the intensity for outputting the warning is set to be the strongest.

(F) The intensity for outputting a warning is set according to the face information. Specifically, the intensity for outputting a warning is set according to the time change of the face information.

Specifically, although the condition (C) is not satisfied, but there is a time change in the face information, the possibility is high such that the driver performs a safety confirmation action which is not sufficient, as compared with the case where there is no time change in the face information. Thus, the intensity of outputting the warning is set to be weak.

(G) The intensity for outputting a warning is set according to at least one of the warning time and the number of warnings.

Specifically, although the condition (D) is not satisfied, but at least the warning time or at least the number of warnings is increased, since the warning to the driver is performed that may be not sufficient, the intensity of the warning output is set to be weaker as the warning time or the number of warnings is increased.

(H) The intensity for outputting a warning is set according to the time change of the collision prediction time.

Specifically, although the condition (E) is not satisfied but the collision prediction time becomes long due to the time change of the collision prediction time, it indicates that the distance between the peripheral object and the own vehicle becomes longer. Therefore, although the condition (E) is not satisfied, when the collision prediction time becomes long due to the time change of the collision prediction time, the intensity of the warning output is set to be weaker as compared with the case where the collision prediction time is shortened due to the time change of the collision prediction time.

(I) When the visibility of the surrounding environment is good, the intensity of outputting the warning is set to be weaker than when the visibility of the surrounding environment is poor.

For example, when a peripheral object is in front, the intensity for outputting a warning is set to be weak. Further, for example, in the case of fine weather, the intensity for outputting a warning is set to be weak. Further, for example, when the outside of the own vehicle is bright as in the daytime, the intensity for outputting a warning is set to be weak.

Subsequently, in S18, the control device 20 outputs a warning from the meter 31, the CID 32, the HUD 33, the speaker 34, the peripheral visual field device 35, and the haptic device 36 that a peripheral object exists at a set intensity.

For example, when the intensity for outputting a warning is set to be weak, a warning using at least visual or auditory may be performed. Specifically, the light turns yellow while the caution image may be displayed on any of the meter 31, the CID 32, and the HUD 33, the speaker 34 may output a warning sound at a low volume or low tone, and the peripheral vision device 35 may turn down the light or blink at a long interval.

Further, for example, when the intensity for outputting the warning is set to be strong, the warning may be given using all of the visual, auditory, and tactile senses. Specifically, at least one of the meter 31, the CID 32, and the HUD 33 displays a warning image while the light lights up in red, the speaker 34 outputs a loud or high-pitched warning sound, and the peripheral vision device 35 becomes bright and blinks with a short sensation, and a strong vibration is output from the haptic device 36.

Although an example of output by the meter 31, the CID 32, the HUD 33, the speaker 34, the peripheral vision device 35, and the haptic device 36 is described, a warning may be output due to a light emission mode, a sounding mode, and a vibration mode different from the above-mentioned example. Further, a warning may be output by a combination of devices different from the above-mentioned example.

Subsequently, in S19, the control device 20 increments and updates the warning time and the number of warnings stored in the memory 22. After that, the warning control process of FIG. 3 is terminated.

### 3. Effects

The above-described embodiment provides the following effects.

(3a) In the present embodiment, when a peripheral object that should be alerted to the driver of the own vehicle is detected, it is first determined whether or not the condition for outputting a warning is satisfied based on the state information and the environmental information. As a result, even when a peripheral object that should be alerted to the driver is detected, it is possible to prevent the warning from being output if the need for warning is low. Even when a warning is output, the strength at which the warning is output is set based on the status information and the environmental information. As a result, even when a peripheral object that should be alerted to the driver is detected, it is possible to set the intensity for outputting the warning to be weak if the need for warning is low. Therefore, it is possible to suppress the output of an excessive warning when the need for warning is low for peripheral objects. As a result, it is possible to reduce the driver of the own vehicle from feeling annoyed by the warning.

(3b) In the present embodiment, it is determined that the warning is not output when the time change of the face information satisfies a predetermined condition. That is, when the time change of the face information satisfies a predetermined condition, it is highly likely that the driver has performed a sufficient safety confirmation action, and it is considered that there is little need to give a warning, so that it is possible to be in a state in which the warning is not output. As a result, it is possible to prevent the warning from being output unnecessarily.

Further, in the present embodiment, when the time change of the face information does not satisfy the predetermined condition, a warning is output. Then, the intensity for outputting the warning is set according to the time change of the face information. For example, when the time change of the face information itself can be confirmed, it may not be sufficient to determine that the warning is not output, but it is highly possible that the driver has performed a safety confirmation action. Since it is considered that there is little need to set the intensity for outputting the warning strongly, the intensity for outputting the warning may be set weakly. As a result, even when a warning is output, the troublesomeness of the driver can be reduced.

(3c) In the present embodiment, when the warning time is at least a predetermined time or more, or at least the number of warnings is equal to or larger than a predetermined number of times, it is determined that the warning is not output. That is, when the driver has been warned for a sufficient amount of time or number of times, it is highly likely that the driver already knows that the vehicle cannot start, and it is considered that there is little need to warn, so that it is in a state in which the warning is not given. As a result, it is possible to prevent the warning from being output unnecessarily.

Further, in the present embodiment, when the warning time is at least shorter than the predetermined time or at least the number of warnings is less than the predetermined number of times, a warning is output. The intensity for outputting the warning is set according to at least one of the warning time and the number of warnings. For example, when the warning time or the number of warnings is increasing, it is not enough to determine that the warning is not output, but the warning to the driver is repeatedly performed. Since it is considered that there is little need to set the intensity for outputting the warning strongly, the intensity for outputting the warning may be set weakly. As a result, even when a warning is output, the troublesomeness of the driver can be reduced.

(3d) In the present embodiment, it is determined that the warning is not output when the brake pressure is equal to or higher than the predetermined pressure. That is, when the brake pedal is strongly depressed, it is considered that the driver has a low intention to start the vehicle and the need for a warning is low, so that it may be set to a state in which the warning is not output. As a result, it is possible to prevent the warning from being output unnecessarily.

(3e) In the present embodiment, when the traffic light detected on the traveling path based on the captured image shows a red light, it is determined that the warning is not output. In other words, when a red light is detected, it is highly likely that the driver already knows that the vehicle cannot start, and it is considered that there is a little need to warn, so that it may be set to a state in which the warning is not output. As a result, it is possible to prevent the warning from being output unnecessarily.

(3f) In the present embodiment, when the predicted collision time with a peripheral object is equal to or longer than a predetermined threshold value, it is determined that the warning is not output. That is, when a collision with a peripheral object is predicted for a long time, it is considered that there is little need to give a warning, so that it may be set to a state in which the warning is not output. As a result, it is possible to prevent the warning from being output unnecessarily.

Further, in the present embodiment, when the collision prediction time is smaller than a predetermined threshold value, a warning is output. Then, the intensity for outputting the warning is set according to the time change of the collision prediction time. For example, when the collision prediction time becomes long due to the time change of the collision prediction time, it is suggested that the distance between the peripheral object and the own vehicle is long. For this reason, it is considered that there is little need to set the strength to output the warning strongly, so the strength to output the warning is weaker than when the collision prediction time is shortened due to the time change of the collision prediction time. As a result, even when a warning is output, the troublesomeness of the driver can be reduced.

(3g) In the present embodiment, it is possible to change a predetermined threshold value regarding the collision prediction time according to the direction in which the surrounding vehicle exists with respect to the own vehicle, the weather information, and the brightness information. As a result, when the visibility of the surrounding environment is poor, it is possible to make it easier to output a warning as compared with the case where the visibility of the surrounding environment is good. Therefore, while suppressing the output of an excessive warning, it is possible to consider the safety in an environment where it is difficult to determine that the situation is such that the need for warning is low.

Further, in the present embodiment, when the visibility of the surrounding environment is good, the intensity of outputting the warning is set to be weaker than that when the visibility of the surrounding environment is poor. As a result, even when a warning is output, the troublesomeness of the driver can be reduced.

(3h) In the present embodiment, it is determined whether or not the condition for resetting the warning time and the number of warnings is satisfied. This makes it easier to output a warning when the environment is such that a warning should be output at a new intersection or after a two-step stop.

Note that S11 corresponds to the processing as the acquisition unit, S12 corresponds to the processing as the detection unit, S15 and S17 correspond to the processing as the processing unit, and S16 and S18 correspond to the processing as the output unit. S19 corresponds to the processing as a storage unit.

### 4. Other Embodiments

While the embodiment of the present disclosure has been described above, the present disclosure is not limited to the above embodiment and can be variously modified.

(4a) In the above embodiment, it is determined based on the state information and the environmental information whether or not the condition for outputting the warning that there is a peripheral object to be alerted to the driver of the own vehicle is satisfied, and the intensity for outputting a warning is set when it is determined that the output condition is satisfied. Alternatively, for example, based on the state information or the environmental information, the determination as to whether or not the condition for outputting the warning is satisfied and the setting of the strength for outputting the warning may be executed. Further, for example, it may be determined only whether or not the condition for outputting the warning is satisfied, or only the intensity for outputting the warning may be set.

(4b) In the above embodiment, it is determined that the condition for outputting the warning is not satisfied when at least one of the conditions (A) to (E) is satisfied, alternatively, the determination method may not be limited to this. For example, it may be determined that the condition for outputting a warning is not satisfied when all the conditions (A) to (E) are satisfied. Further, for example, it may be determined that the condition for outputting a warning is not satisfied when the condition of any combination of (A) to (E) is satisfied.

(4c) In the above embodiment, of the strengths set as shown in (F) to (I), the configuration in which the strength for outputting the warning is set to be the strongest is exemplified, alternatively, the method for setting the strength may not be limited to this. For example, it may be set based on the priority attached to the condition for determining the setting as shown in (F) to (I).

(4d) As a method of changing a predetermined threshold value regarding a collision prediction time according to weather information, a method of raising a predetermined threshold value regarding a collision prediction time is exemplified to be larger than in the case of fine weather when the weather is not sunny weather. However, individual thresholds may be set for each of the weather conditions such as sunny weather, cloudy weather, rain, fog, and snow.

(4e) In the determination of whether or not the condition for outputting the warning is satisfied, the condition and the threshold value which are the basis of the ease of warning may be set according to the personal preference based on the personal authentication of DSM21.

(4f) Even when it is determined that the condition for outputting the warning is not satisfied, the warning may be set to be output only once in the first cycle in which the warning control process is executed.

(4g) The control device 20 and the technique according to the present disclosure may be achieved by a dedicated computer provided by constituting a processor and a memory programmed to execute one or more functions embodied by a computer program. Alternatively, the control device 20 and the technique according to the present disclosure may be achieved by a dedicated computer provided by constituting a processor with one or more dedicated hardware logic circuits. Alternatively, the control device 20 and the technique according to the present disclosure may be achieved using one or more dedicated computers constituted by a combination of the processor and the memory programmed to execute one or more functions and the processor with one or more hardware logic circuits. The computer program may store a computer-readable non-transitional tangible recording medium as an instruction to be executed by the computer.

(4h) A function of one configuration element in the embodiment described above may be implemented by multiple configuration elements. Functions of multiple configuration elements may be implemented by one configuration element. Part of the configuration of the above embodiment may be omitted. At least a part of the configuration of the embodiment described above may be added to, replaced with another configuration of the embodiment described above, or the like.

(4i) In the present disclosure, in addition to the control device 20 described above, a system having the control device 20 as a component, a program for operating a computer as the control device 20, a medium on which this program is recorded, a warning control method, and the like can be realized in various forms.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium.

It is noted that a flowchart or the processing of the flowchart in the present application includes sections (also referred to as steps), each of which is represented, for instance, as S11. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A control device mounted in a vehicle, comprising:
an acquisition unit configured to acquire state information indicating a state of a driver of the vehicle, environmental information indicating an environment around the vehicle, and vehicle information including at least a current position of the vehicle;
a detection unit configured to detect an object existing in a vicinity of the vehicle to be alerted to the driver from the environmental information;
a processing unit configured to execute at least one of a process for determining whether to output a warning that the object exists and a process for setting an intensity of the warning to be output, based on at least one of the state information and the environmental information when the detection unit detects the object; and
an output unit configured to output the warning according to a result of the process executed by the processing unit, wherein:
the acquisition unit acquires face information indicating at least one of a line of sight of the driver and a face orientation of the driver as the state information;
the processing unit determines that the warning is not output when the face information satisfies a predetermined condition; and
the predetermined condition is that a change amount of the face information is equal to or larger than a predetermined change amount.

2. The control device according to claim 1, wherein:
the acquisition unit acquires face information indicating at least one of a line of sight of the driver and a face orientation of the driver as the state information; and
the processing unit sets the intensity of the warning to be output according to the face information.

3. The control device according to claim 1, further comprising:
a storage unit configured to store at least one of time when the warning is output and a numerical number of times the warning is output as the environmental information, wherein:
the processing unit determines that the warning is not output when at least the time when the warning is output is equal to or longer than a predetermined time or at least the numerical number of times the warning is output is equal to or larger than a predetermined numerical number of times.

4. The control device according to claim 1, wherein:
a storage unit configured to store at least one of time when the warning is output and a numerical number of times the warning is output as the environmental information, wherein:
the processing unit sets the intensity of the warning to be output according to at least one of the time when the warning is output and the numerical number of times the warning is output.

5. The control device according to claim 1, wherein:
the acquisition unit acquires information on a brake operation of the driver from a brake sensor of the vehicle as the state information; and
the processing unit determines that the warning is not output when a depression amount of a brake pedal of the vehicle detected from the information on the brake operation satisfies a predetermined condition.

6. The control device according to claim 1, wherein:
the acquisition unit acquires a captured image from a camera mounted in front of the vehicle as the environmental information; and
the processing unit determines that the warning is not output when a traffic light indicates a red light under a condition that the traffic light for displaying a display that restricts a traveling of the vehicle is detected based on the captured image.

7. The control device according to claim 1, wherein:
the processing unit calculates a collision prediction time, which is the time when a collision between the vehicle and the object is predicted, as the environmental information based on the vehicle information and information of the object; and
the processing unit determines that the warning is not output when the collision prediction time is equal to or longer than a predetermined threshold value.

8. The control device according to claim 1, wherein:
the processing unit calculates a collision prediction time, which is the time when a collision between the vehicle and the object is predicted, as the environmental information based on the vehicle information and information of the object; and
the processing unit sets the intensity of the warning to be output according to a time change of the collision prediction time.

9. The control device according to claim 7, wherein:
the processing unit executes at least one of a setting for increasing a predetermined threshold value relating to the collision prediction time used in determining whether to output the warning and a setting for increasing the intensity of the warning to be output when the detection unit detects the object existing behind the vehicle.

10. The control device according to claim 7, wherein:
the acquisition unit acquires weather information indicating a weather around the vehicle as the environmental information; and
the processing unit executes at least one of a setting for changing a predetermined threshold value relating to the collision prediction time used in determining whether to output the warning and a setting of the intensity of the warning to be output, according to the weather information.

11. The control device according to claim 7, wherein:
the acquisition unit acquires brightness information indicating a brightness outside the vehicle as the environmental information; and
the processing unit executes at least one of a setting for changing a predetermined threshold value relating to the collision prediction time used in determining whether to output the warning and a setting of the intensity of the warning to be output, according to the brightness information.

12. The control device according to claim 1, further comprising:
one or more processors; and
a memory coupled to the one or more processors and storing program instructions that when executed by the one or more processors cause the one or more processors to provide at least: the detection unit; the processing unit; and the output unit.
